(19) United States
(12) Patent Application Publication
(10) Pub. No.: US 2016/0361926 A1
(43) Pub. Date: Dec. 15, 2016

(54) Inkjet Recording Device

(71) Applicant: Hitachi Industrial Equipment Systems Co., Ltd., Tokyo (JP)

(72) Inventors: Mamoru OKANO, Tokyo (JP); Nobuhiro HARADA, Tokyo (JP); Mitsuo IGARI, Tokyo (JP)

(21) Appl. No.: 15/047,964

(22) Filed: Feb. 19, 2016

(30) Foreign Application Priority Data
Jun. 10, 2015 (JP) 2015-117120

(51) Int. Cl. B41J 2/165

(52) U.S. Cl. CPC B41J 2/16517

(57) ABSTRACT

There is provided an inkjet recording device including a print head containing a nozzle that discharges ink to perform printing on a print medium. In the inkjet recording device, an ink recovery device that recovers floating ink with electrostatic force is provided on a lateral face of the print head. Thereby, the outside and the inside of the print head can be suppressed from being stained with the floating ink without the amount of evaporation of a solvent increasing.

### INCORPORATION BY REFERENCE

The present application claims priority from Japanese application JP2015-117120 filed on Jun. 10, 2015, the content of which is hereby incorporated by reference into this application.

### BACKGROUND OF THE INVENTION

The present invention relates to an inkjet recording device that continuously ejects ink from a nozzle and performs printing on a print medium.

There is US2010/0207976 as a background art in the present technical field. In US2010/0207976, a configuration is disclosed in which an ink discharge port through which ink is discharged and a number of holes disposed in the periphery of the ink discharge port are provided on the end face of a cover of a print head, and air is discharged through the large number of holes by sending the air from the base of the print head toward the holes.

### SUMMARY OF THE INVENTION

An inkjet recording device can perform contactless printing on a print object since it performs the printing by allowing ink to fly from an ink discharge port of a print head. When the distance between the print head and the print object becomes close, however, there can be a case where some ink bounces back on the print head side upon impact of the ink onto the print medium to stain the surface of the print head.

Moreover, since the bouncing ink has been electrified, it can be attracted to a deflection electrode inside the print head to stain the electrode, which possibly causes print quality to deteriorate.

According to the technology in US2010/0207976, since an air flow from the inside to the outside of the print head is generated, ink mist from the print medium can be prevented from staining the print head.

Here, for an inkjet recording device in a continuous system, a solvent contained in the ink evaporates during flight of the ink in the print head. Hence, with the configuration disclosed in US2010/0207976 applied to the same, evaporation of the solvent increases, and thus, a large amount of the solvent that has evaporated is discharged from the inside of the print head to the outside thereof.

Since a concentration of the ink that is circulated becomes higher as the evaporation of the solvent in the ink progresses more, an extra solvent is needed to be supplied by the amount of the evaporation, which causes a running cost to increase. Moreover, an amount of discharge of the solvent that has evaporated to the outside becomes large, which can malignly impair an environment.

Therefore, an object of the present invention is to provide an inkjet recording device capable of suppressing floating ink from staining the outside and the inside of a print head without an amount of evaporation of a solvent increasing.

To solve the aforementioned problems, a configuration according to the appended claims is adopted by way of example.

While the present application includes a plurality of ways to solve the aforementioned problems, an example of those, if exemplified, is an inkjet recording device including a print head containing a nozzle that discharges ink to perform printing on a print medium, wherein an ink recovery device that recovers floating ink with electrostatic force is provided on a lateral face of the print head.

According to the present invention, there can be provided an inkjet recording device capable of suppressing floating ink from staining the outside and the inside of a print head without an amount of evaporation of a solvent increasing.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating a configuration in which an ink mist recovery device according to a first embodiment of the present invention is mounted on a head;

FIG. 2 is a schematic diagram illustrating an appearance of an inkjet recording device;

FIG. 3 is a schematic diagram for explaining a configuration of the inkjet recording device;

FIG. 4A is a diagram illustrating an appearance of a print head of a conventional inkjet recording device;

FIG. 4B is a diagram illustrating an appearance of the print head, of the conventional inkjet recording device, having a head cover taken off;

FIG. 5 is a diagram illustrating a state of generation of ink mist in printing with the conventional inkjet recording device;

FIG. 6 is a diagram illustrating an appearance of the print head of the inkjet recording device according to the first embodiment of the present invention;

FIG. 7 is a diagram illustrating a configuration of an ink mist recovery device installed in an inkjet recording device according to a second embodiment of the present invention;

FIG. 8 is a diagram illustrating a detailed configuration of the ink mist recovery device according to the first embodiment of the present invention; and

FIG. 9 is a diagram illustrating a state where the surface of the print head is stained with the ink mist that is generated in printing with the conventional inkjet recording device.

### DESCRIPTION OF THE EMBODIMENTS

Hereafter, embodiments of the invention are described according to the drawings. First, an outline of an inkjet recording device and problems of the present invention are described using the drawings.

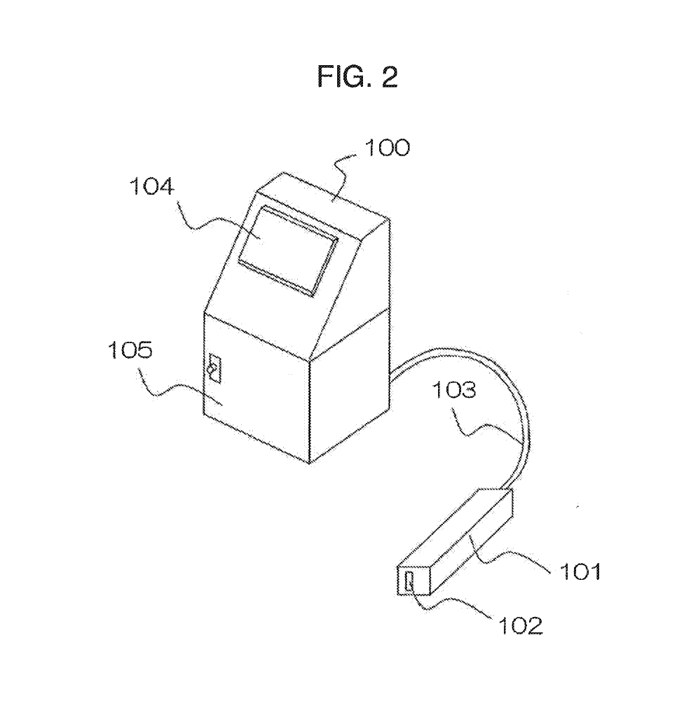

First, a schematic configuration of an inkjet recording device is illustrated using FIG. 2. Inside a body 100, a control system and an ink circulation system of the recording device are present, and maintenance operation can be performed by opening and closing a door 105. Moreover, a head cable 103 is drawn out from the body 100.

The head cable 103 includes a pipe for sending ink from the body 100 to a print head 101, a pipe for recovering the ink from the print heat 101 to the body 100, and wiring for sending electric signals to the print head 101.

Furthermore, in the body 100, a touch panel-type liquid crystal panel 104 for a user inputting a content to be printed, settings of printing and the like is present. During operation of the recording device, a content of control, an operation status and the like of the recording device are displayed on the liquid crystal panel 104.

The print head 101 is made of stainless steel, inside which a print unit that generates ink particles and controls flight of the ink particles is contained. The ink particles generated inside the print head 101 are discharged through an opening 102 provided at the bottom face to form an image by sticking onto a not-shown print medium.

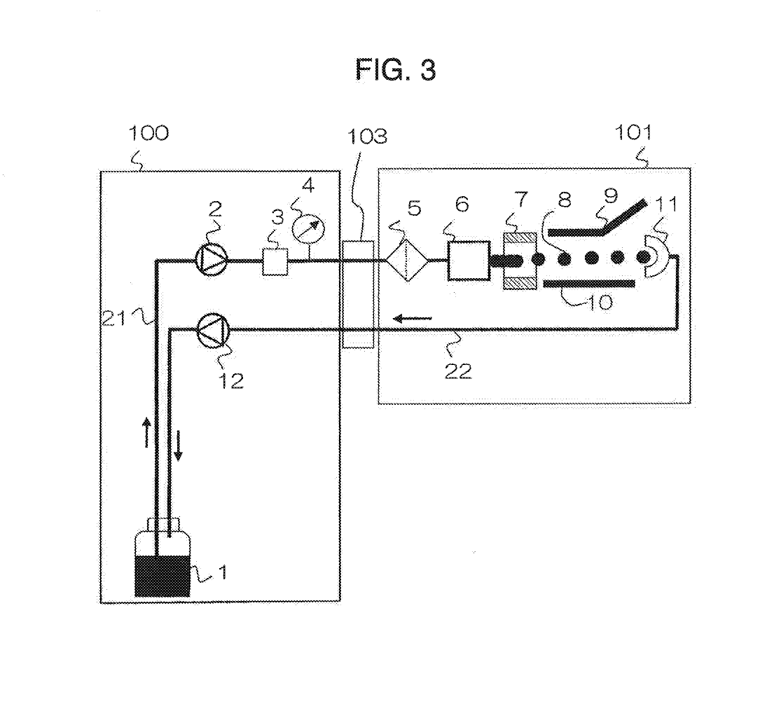

Next, a schematic configuration of the ink circulation system and the print unit of the inkjet recording device is described using FIG. 3. An ink supply path 21 is constituted of an ink container 1 that contains the ink, a supply pump 2 that presses and sends the ink, a pressure regulation valve 3 that regulates the pressure of the ink, a pressure gauge 4 that displays the pressure of the supply ink, and a filter 5 that traps foreign matter in the ink, and supplies the ink to a nozzle 6.

A piezoelectric element is attached to the nozzle 6. By applying a sine wave at approximately 70 kHz to the piezoelectric element, the ink which is ejected from an orifice present at the end to the nozzle 6 is dispersed into particles during its flight.

To an electrification electrode 7, a recording signal source (not shown) is connected, and ink particles 8 which are regularly ejected from the nozzle 6 are electrified by applying a recording signal voltage to the electrification electrode 7. An upper deflection electrode 9 is connected to a high voltage source (not shown) and a lower deflection electrode 10 is grounded, and thus, an electrostatic field is formed between the upper deflection electrode 9 and the lower deflection electrode 10. The electrified ink particles 8 are deflected during passing through the electrostatic filed in accordance with the amounts of electrification of the ink particles 8 themselves to form an image by sticking onto a not-shown print medium.

An ink recovery path 22 is constituted of a gutter 11, a filter 12 and a recovery pump 14. The ink particles 8 that are not electrified with the electrification electrode 7 and not deflected during passing through the electrostatic field are recovered with the gutter 11 and returned to the ink container 1 to be reused. Notably, since the ink recovery path 22 including the filter 12 is formed inside the print head 101, it is present where it is not visually seen from the outside.

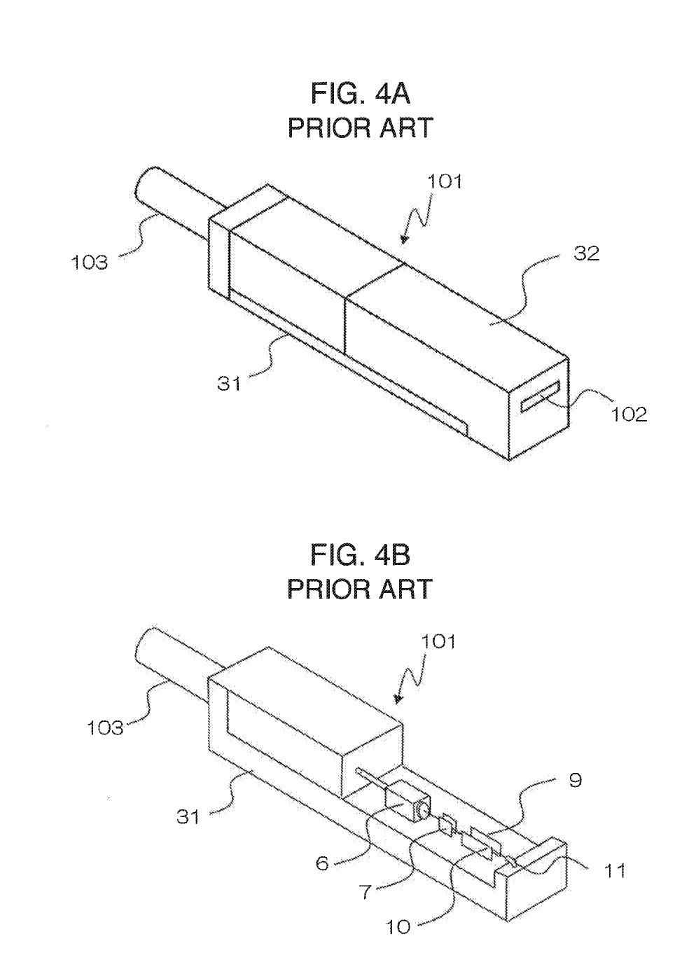

FIG. 4A illustrates an appearance of a conventional print head 101. In the print head 101, components which are used for printing, such as a nozzle, an electrification electrode and deflection electrodes are implemented, and the components are covered by a head cover 32 having a slit 102 through which the ink flies.

FIG. 4B illustrates a state of the conventional print head 101 having the head cover 32 taken off. As described using FIG. 3, the nozzle 6, the electrification electrode 7, the upper deflection electrode 9, the lower deflection electrode 10 and the gutter 11 are implemented on a base member 31 of the print head 101. The ink droplets that are electrified and continuously ejected from the nozzle fly through the slit 102 of the head cover 32 and stick onto the print medium.

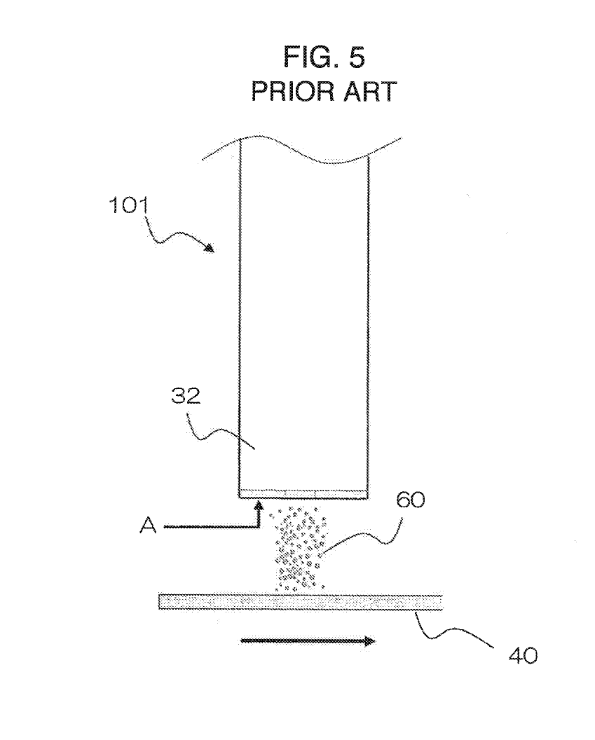

FIG. 5 is a diagram illustrating a state of generation of ink mist in printing with a conventional inkjet recording device and illustrates a state of printing on a surface of a print medium with the inkjet recording device. A print medium 40 is transferred at a position of opposition to the fixed print head 101, and thereby, characters and signs are printed on the print medium.

In this stage, the ink which has reached the print medium sometimes bounces back depending on the speed of the ink particles discharged from a discharge port 102 of the print head 101 and the distance between the print head 101 and the surface of the print object. Moreover, the ink that has bounced turns to mist to generate ink mist 60. The amount of the ink mist is larger as the interval between print dots is narrower. When the distance between the print head and the print medium is short, the ink mist 60, which has been electrified in the print head, tends to stick onto the metal-made head cover.

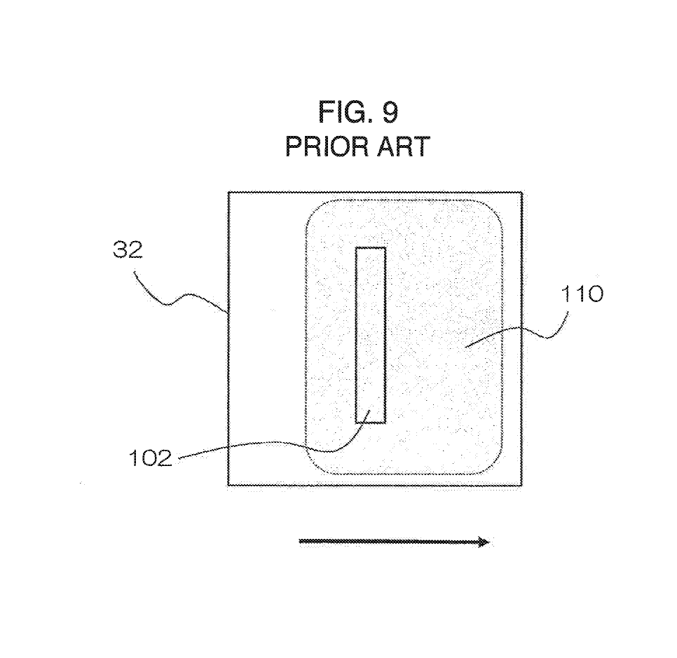

FIG. 9 is a diagram illustrating a state where the surface of the print head is stained with the ink mist which is generated in printing with the conventional inkjet recording device, and illustrates a state where the head cover 32 of the print head 101 is stained with the ink mist (face A in FIG. 5).

To the surface of the head cover 32, stain 110 sticks due to the ink mist which has bounced. The stain 110 is present to be biased on the side of the direction in which the print medium is transferred, and the ink mist comes into the head cover 32 through the slit 102.

Since the upper deflection electrode 9 and the lower deflection electrode 10, which form the electrostatic field, are in the head cover 32, the electrified ink mist comes close to the upper deflection electrode 9 and sticks to the end part thereof. The ink mist 60 sticking to the upper deflection electrode 9 causes a change in orientation and magnitude of the electric field formed by the upper deflection electrode 9 and the lower deflection electrode 10, which results in the flying ink droplets not flying in the predetermined direction. This further leads to a change in position of their sticking onto the print medium and a decrease in print quality.

A configuration of the present invention to solve these problems is described with the following embodiments.

### First Embodiment

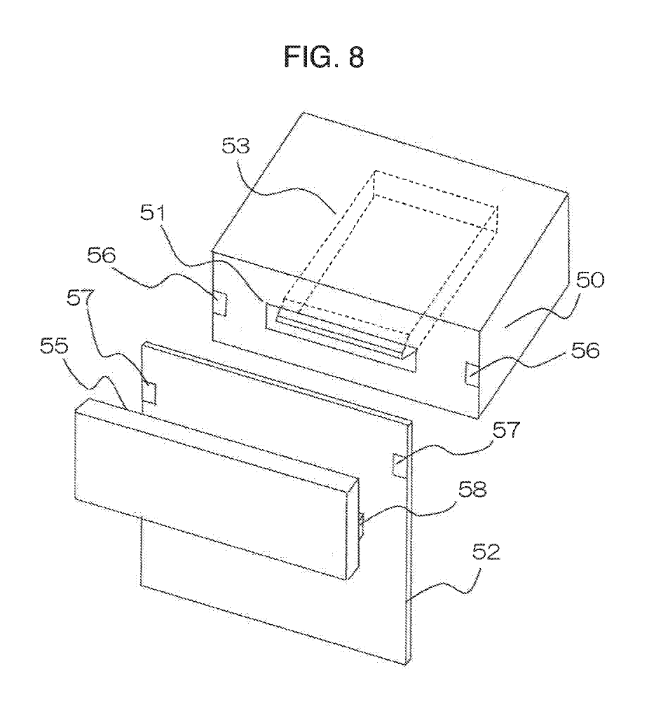

Hereafter, a configuration according to a first embodiment of the present invention will be described using the drawings. First, a detailed configuration of an ink mist recovery device is described using FIG. 8. The ink mist recovery device has an electrode 53 implemented inside a casing member 50, which electrode is configured to be able to apply voltage by being connected to a wire.

One face of the casing member 50 has a slit 51, through Which the electrode 53 inside is configured to be able to be visually seen. On the face in which the slit 51 is present, grooves 56 are present. Holes 57 are opened in an absorption member 52 so as to have approximately the same interval and dimensions as those of the grooves 56.

Projections 58 are provided in a fixing member 55 to fix the absorption member 52 by sandwiching the absorption member 52 between the fixing member 55 and the casing member 50 and inserting the projections 58 of the fixing member into the grooves 56 of the casing member.

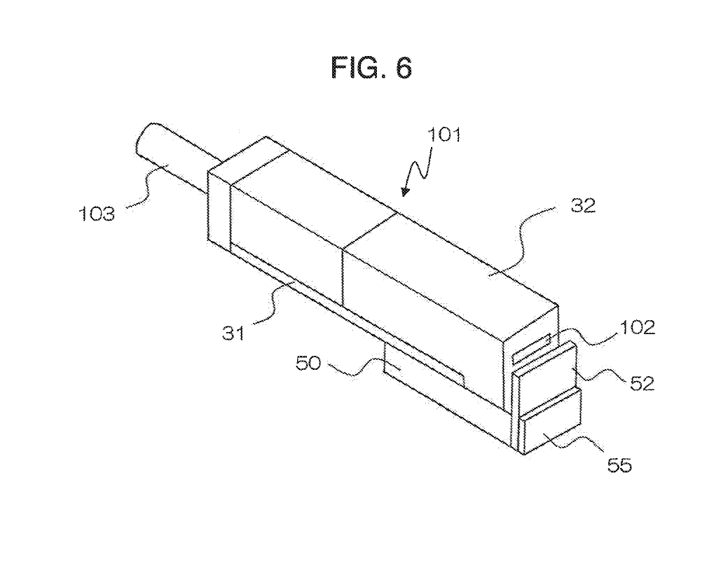

The absorption member 52 is plate-shaped, and as illustrated in FIG. 6, its dimensions are dimensions in which the surface of the head cover 32 is covered such that the slit 102 present in the head cover of the print head 101 is not closed.

Moreover, the face on which the absorption member 52 is fixed to the casing member 50 is more on the print medium side than the position of the slit 102 present in the head cover 32 of the print head 101.

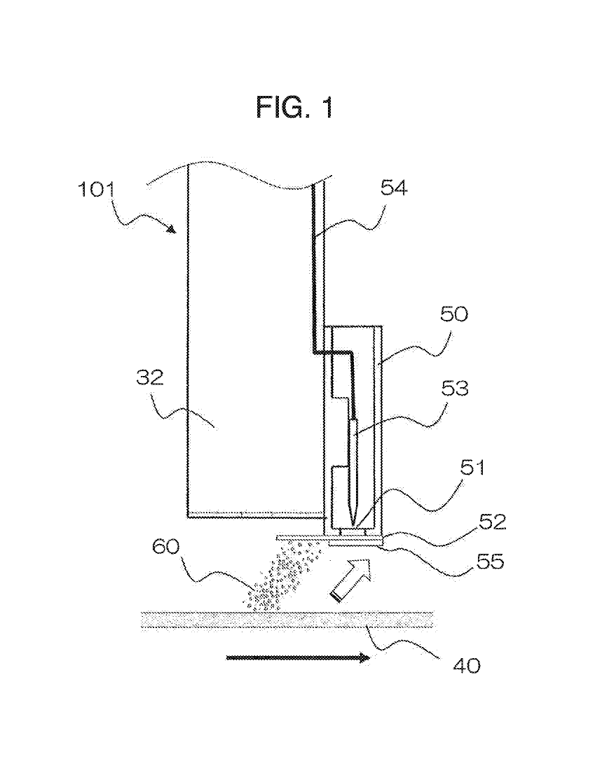

Next, a recovery effect of the ink mist recovery device is described using FIG. 1. FIG. 1 is a diagram illustrating a configuration in which the ink mist recovery device according to the first embodiment of the present invention is mounted on the head, and the ink mist recovery device is installed on a lateral face of the print head 101. Ink mist can be efficiently recovered in particular when implemented on the downstream side toward which the print medium is transferred.

Application of voltage by connecting the wire 54 to the electrode 53 generates an electric field between the electrode 53 and the print medium 40. The wire is contained along with the ink pipes and the other wires in the head cable.

The ink droplets flying from the print head 101 reach and stick onto the surface of the print medium 40, and a part of the ink becomes fine mist to float. Since the ink mist is electrified, it is attracted to the absorption member 52 of the mist recovery means and sticks onto the surface thereof.

Thus, the ink mist does not come close to the slit of the print head and can be suppressed from coming into the print head. Accordingly, to stain the upper deflection electrode 9 in the print head is reduced. The orientation and the magnitude of the electric field formed by the upper deflection electrode 9 and the lower deflection electrode 10 do not change, and therefore, the ink droplets fly in the predetermined direction, which can suppress deterioration of print quality.

Here, when the ink mist 60 is absorbed on the surface of the absorption member 52, it solidifies thereon with its solvent component quickly evaporating. Although the ink is uniformly solidifying in a planar shape, the thickness of the solidifying ink becomes to have a distribution before long.

A portion of thickening layer of the ink further causes the ink to stick thereonto and to accumulate into a needle shape before long, which can result in electric discharge from its tip, While the amount of absorption on the absorption member is yet small, almost no current flows. But once the amount of absorption of the ink exceeds a predetermined amount, current starts to flow due to local electric discharge arising.

When the amount of the current flowing through the electrode 53 becomes large, a value of output voltage from a high-voltage power supply provided in a not-shown control unit decreases. Therefore, it is configured that this decrease in value of the voltage is detected to put a display for encouraging exchange of the absorption member 52 on an operation screen of the inkjet recording device. When the amount of the current becomes further large, the value of output voltage from the high-voltage power supply further decreases. Hence, control to stop operation of the inkjet device is performed.

As mentioned above, time when the absorption member 52 is usable has an upper limit and the time depends on the number of print dots, the distance between the print head and the print medium, the interval between the print dots, and the like. When the number of the print dots and the distance between the print head and the print medium are held to be constant in printing, time for exchange of the absorption member 52 can be predicted. Therefore, when running out of the usable time, printing is suspended and the absorption member 52 is to be exchanged. The inkjet recording device can also be configured to store such data to output a display for encouraging the exchange of the absorption member 52 on the operation screen.

Notably, a material of the absorption member 52 is determined depending on the polarity of charge given to the ink. When printing is performed with the ink given the negative charge, nylon, paper or the like, which tends to gain positive electrification, is suitable. When printing is performed with the ink given the positive charge, Teflon® or the like, which tends to gain negative electrification, is suitable.

### Second Embodiment

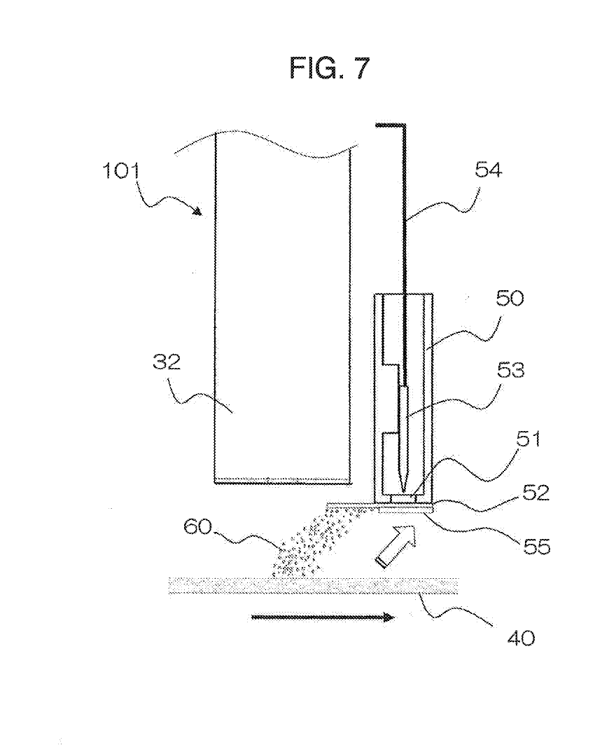

FIG. 7 is a diagram illustrating a configuration of an ink mist recovery device installed in an inkjet recording device according to a second embodiment of the present invention.

In this example, mist recovery means is separate from the print head 101. In this case, even during printing, since the ink mist recovery means is movable, the absorption member 52 can be exchanged.

Moreover, even for a print head that does not have mist recovery means as, for example, in an inkjet recording device that was produced in the past and is operating in the market, the ink mist recovery means can be posteriorly installed.

With the configuration as above, since the ink mist arising by bouncing from the print medium in printing can be trapped, the surface of the print head can be prevented from being stained. In addition to this, since there is caused no disorder in flying direction of the ink, which disorder can arise from the ink mist coming into the inside of the print head through the slit thereof and sticking to the deflection electrode inside the print head, print quality does not deteriorate. Therefore, there can be provided an inkjet recording device which performs printing with stable quality. Moreover, the amount of evaporation of the ink solvent does not increase, which can prevent environmental pollution from increasing.

It should be further understood by those skilled in the art that although the foregoing description has been made on embodiments of the invention, the invention is not limited thereto and various changes and modifications may be made without departing from the spirit of the invention and the scope of the appended claims.

1. An inkjet recording device comprising a print head containing a nozzle that discharges ink to perform printing on a print medium, wherein
an ink recovery device that recovers floating ink with electrostatic force is provided on a lateral face of the print head.

2. The inkjet recording device according to claim 1, wherein
the ink recovery device is constituted of an electrode, a casing member containing the electrode, an ink absorption member detachably attachable to the casing member, a power supply that applies voltage to the electrode, and a wire connecting the electrode to the power supply.

3. The inkjet recording device according to claim 2, wherein
a face on which the ink absorption member is attached to the casing member of the ink recovery device is at a position closer to the print medium than a printing discharge face of the print head.

4. The inkjet recording device according to claim 1, wherein
the ink recovery device is installed at a position, of the print head, on a downstream side toward which the print medium is transferred.

5. The inkjet recording device according to claim 2, comprising:
a calculation unit that calculates time for exchange of the ink absorption member based on printing data and data such as a transfer speed of the print medium; and a display unit that displays information for recommending exchange of the ink absorption member based on a calculation result from the calculation unit.

6. The inkjet recording device according to claim 2, comprising a control unit, wherein
by the control unit, a magnitude of current flowing in the power supply which applies the voltage to the electrode installed in the ink recovery device is detected, and when the current flows with a magnitude equal to or greater than a predetermined magnitude of the current, control is made such that supply of the voltage to the electrode of the ink recovery device is stopped and printing by the inkjet recording device is stopped.

7. The inkjet recording device according to claim 2, wherein
the ink absorption member is composed of a material that tends to be electrified with a polarity reverse to a polarity of electrification of the ink.
